(19) United States
(12) Patent Application Publication
(10) Pub. No.: US 2002/0055902 A1
(43) Pub. Date: May 9, 2002

(54) Methods. apparatus, and articles of manufacture for managing nutrient trading

(76) Inventor: Paul Faeth, Alexandria, VA (US)

Correspondence Address: Finnegan, Henderson, Farabow,, Garrett & Dunner, L.L.P., 1300 I Street, N.W., Washington, DC, 20005-3315, US

(21) Appl. No.: 09/986,790

(22) Filed: Nov. 9, 2001

Related U.S. Application Data
(60) Provisional application No. 60/246,745, filed on Nov. 9, 2000.

(51) Int. Cl. G06F 17/60

(52) U.S. Cl. 705/37

(57) ABSTRACT

Methods, systems, and articles of manufacture for performing nutrient trading is described. In one configuration consistent with certain features related to the present invention, a server may provide available nutrient information associated with a source based on current management practices and nutrient information associated with the source. The available nutrient information may include estimated nutrient loads, costs, and available nutrient credits. The server may also manage nutrient trading between market participants associated with respective watershed sources. The server may allow a market participant to present a trade offer for buying and/or selling nutrient credits to the server. The server may make the trade offer available to other market participants and process bids associated with the offer. Once a bid is accepted by the market participant who presented the trade offer, the server may register the accepted bid as a nutrient trade.

### BACKGROUND OF THE INVENTION

This application is based upon and claims the benefit of priority from U.S. Provisional Application No. 60/246,745 by Paul Faeth, filed Nov. 9, 2000, the contents of which are incorporated herein by reference.

1. Field of the Invention

The present invention relates to techniques for reducing waterway pollution, and more particularly, to methods, systems, and articles of manufacturer for managing nutrient trading.

2. Description of the Related Art

In the United States today, almost 3,400 waterways are impaired by nutrient pollution. To address the problems associated with pollution, federal and state environmental programs, such as the Clean Water Act, have been created to help improve water quality. Although such programs have increased awareness of nutrient pollution, the cost of regulatory requirements have prevented the United States from meeting national anti-pollution goals.

The World Resources Institute, in its publication Fertile Ground, explored the cost-effectiveness and environmental performance of various strategies to reduce nutrient loads in polluted waterways. Findings suggest that more flexible approaches to water quality management, including nutrient trading among point and nonpoint sources, may potentially provide greater improvements in water quality at a much lower cost.

Nutrient trading is a market-based approach for protecting and improving water quality impaired by excessive amounts of nutrients such as phosphorus or nitrogen. Trading involves two basic steps. The first step is setting a goal for the total amount of nutrients that enter waters in a watershed. This goal usually takes the form of a mandatory cap on the total quantity of nutrients entering the water. The goal, however, could also be a percentage reduction goal that is pursued through a voluntary, open program. The total amount of allowable pollution is then allocated among the sources that will participate in the trading program.

The second step in trading involves allowing sources to trade in a manner that meets local and watershed-wide water quality goals. Once pollution allowances are allocated, sources with low-cost pollution reduction options have an incentive to reduce nutrient loadings beyond what is required of them and to sell the excess credits to sources with higher control costs. Through a series of trades, pollution reduction efforts get reallocated to the sources that have the lowest cost opportunities to reduce pollution. This flexibility greatly reduces the total cost of improving water quality.

By allowing flexibility associated with the source of the reductions, trading may reduce the total cost of reducing nutrient loadings and improving water quality. Based on this theory, a number of states and communities in the United States are implementing pilot programs or considering watershed-based trading of nutrient loadings.

Although conventional nutrient trading programs are growing in popularity, the success of these programs requires the management of several tasks. These tasks may include the provision of information to market participants, facilitation of trades, tracking and documentation of market activity, an accurate estimation of loads and credits for trading, and technical assistance. Because conventional nutrient trading programs lack the ability to properly manage these tasks, potential trading participants may find such programs not cost effective and, therefore, decide not to participate in nutrient trading.

### SUMMARY OF THE INVENTION

It is, therefore, desirable to have a method, system, and article of manufacture that provides an environment for managing nutrient trading between market participants.

In accordance with certain aspect of the present invention, a method is provided for performing nutrient trading, comprising posting a trade offer for an amount of available nutrient credits, receiving a bid for the trade offer, accepting the bid for the trade offer, and registering the bid as a nutrient trade.

In accordance with another aspect of the present invention, a system is provided for performing nutrient trading, comprising a source, means for posting a trade offer for an amount of available nutrient credits, means for receiving a bid for the trade offer, means for accepting the bid for the trade offer, and means for registering the bid as a nutrient trade.

In accordance with another aspect of the present invention, a computer-readable medium including instructions is provided for performing a method for determining a nutrient load and an amount of available nutrient credits for a nonpoint source, comprising posting a trade offer for an amount of available nutrient credits, receiving a bid for the trade offer, accepting the bid for the trade offer, and registering the bid as a nutrient trade.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments of the invention and, together with the description, serve to explain the principles of the invention. In the drawings,

FIG. 1 is a diagram of a system for performing nutrient trading consistent certain principles related to the present invention;

FIG. 2 is a screen shot of an exemplary registration form consistent with certain principles related to the present invention;

FIG. 3 is a flow chart of an exemplary process of a nonpoint source worksheet consistent with certain principles related to the present invention;

FIGS. 4-9 are screen shots of exemplary forms that may be used by the nonpoint source worksheet consistent with certain principles related to the present invention;

FIG. 10 is a flow chart of an exemplary process of a point source worksheet consistent with certain principles related to the present invention;

FIGS. 11-14 are screen shots of exemplary forms that may be used by the point source worksheet consistent with certain principles related to the present invention;

FIG. 15 is a flow chart of an exemplary process for nutrient trading consistent with certain principles related to the present invention;

FIGS. 16-20 are screen shots of exemplary forms that may be used in the nutrient trading process consistent with certain principles related to the present invention;

FIG. 21 is a flow chart of an exemplary offer posting process consistent with certain principles related to the present invention;

FIG. 22 is a screen shot of an exemplary form that may be used in the offer posting process consistent with certain principles related to the present invention; and

FIG. 23 is a screen shot of an exemplary trade registry form consistent with certain principles related to the present invention.

### DETAILED DESCRIPTION

Methods, systems, and articles of manufacture consistent with certain principles related to the present invention provide market participants with information and tools associated with nutrient trading from each participant's respective business standpoint. In one configuration consistent with certain features of the present invention, a market participant may receive estimates of nutrient loads associated with their business operations and the costs associated with reducing nutrient loads through various management alternatives. Furthermore, methods, systems, and articles of manufacture consistent with certain aspects of the present invention allows a market participant to access a nutrient trading system to identify potential trading partners, post offers to purchase or sell nutrient reduction credits, and register completed trades. The market participant may use the nutrient trading system to exchange nutrient information, such as technical and policy issues associated with nutrient pollution, with other market participants.

In one configuration related to certain features of the present invention, users may use point and nonpoint source worksheets provided by the nutrient trading system to obtain nutrient information associated with their respective source(s). These worksheets may provide the users with estimates for the nutrient loads of current operation, the costs of reducing nutrient loads by implementing different management options, and the number of credits available for trading based on a selected management option.

In accordance with another aspect of the present invention, a trading market may be provided by the nutrient trading system that allows users associated with point and nonpoint sources to offer nutrient credits for trading with other users associated with other point and nonpoint sources. The trading market may allow a user to view trade offers, post trade offers, and view a trade registry that identifies completed nutrient trades.

Before discussing certain aspects of the present invention, several terms associated with nutrient trading should be defined. These terms include a user, nonpoint sources, point sources, nutrient credit, nutrient load, nutrient emission, control cost, eutrophication, hypoxia, total maximum daily load, spatially explicit delivery model, and revised universal soil loss equation.

In accordance with certain aspects related to the present invention, a user may be an entity wishing to engage in nutrient trading. A user may be an individual or business entity associated with a nonpoint source and/or a point source, and an agency that regulates watersheds. A point source is a pollution source that has an identifiable point of discharge, such as a pipe. Examples of a point source include municipal and industrial treatment facilities. In contrast to point sources, nonpoint sources of pollution are diffused and spread across a landscape. Examples of nonpoint sources include runoff from urban areas, agricultural land, and residential landscapes.

Nutrient load is the amount of nutrients produced by a nonpoint source. Nutrient emission is the amount of nutrient produced by a point source. Nutrients may include, for example, nitrogen and phosphorus.

Nutrient credits are excess nutrient loads or emission allotments held by a user associated with a point and/or nonpoint source. Nutrient credits may be obtained by implementing nutrient management practices in the user's associated source. Control costs may be additional costs (i.e., costs beyond normal operating costs) associated with pollution reduction practices. Control costs may be measured in terms of dollars per unit of pollution reduced.

Eutrophication is a process in which a water source, such as a lake, gradually ages and becomes more biologically productive. Natural eutrophication of a water source may take thousands of years to complete. Natural eutrophication is accelerated by release of excessive amounts of plant nutrients, such as phosphorus and nitrogen into the water. This type of eutrophication may lead to algal blooms, oxygen depletion, and affect fish populations.

Hypoxia occurs when the level of dissolved oxygen in water reaches a low level (i.e., 2 parts per million or lower). Areas of hypoxia, or “dead zones,” are present in more than half of the estuaries of the United States. For example, the largest hypoxic zone off the United States coast and one of the largest hypoxic zones in the world is located near the outflows of the Mississippi and Atchafalaya Rivers in the northern Gulf of Mexico.

Total Maximum Daily Load (TMDL) may include (1) a calculation of the maximum amount of a pollutant that a water body may receive and still meet certain water quality standards, and (2) an allocation of that maximum amount among the point and nonpoint sources of the pollutant in question. For more information regarding water quality standards and TMDLs, see Section 303 of the Clean Water Act.

Spatially Explicit Delivery Model (SEDMOD) is a model for predicting pollution for sediment and associated nonpoint source pollutants. Revised Universal Soil Loss Equation (RUSLE) is a model that may be used to predict soil losses on any field condition where soil erosion by water may occur.

Reference will now be made in detail to the certain aspects related to the present invention, examples of which are illustrated in the accompanying drawings. Wherever possible, the same reference numbers will be used throughout the drawings to refer to the same or like parts.

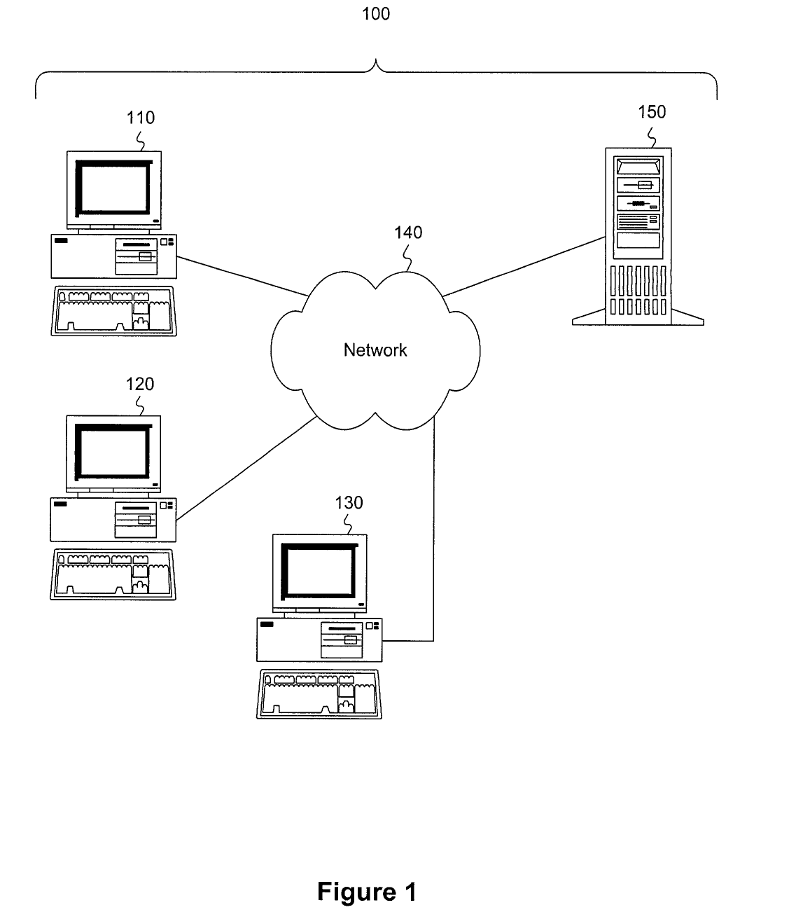

A nutrient trading system 100 for performing nutrient trading consistent with certain principles related to the present invention will now be described with reference to FIG. 1. A nutrient trading system 100 may comprise user stations 110, 120, and 130, a network 140, and a server 150. User stations 110, 120, and 130 may be, for example, a computer unit. The computer unit may contain standard components for inputting, outputting, manipulating, and storing data. For example, the computer unit may comprise a central processing unit (CPU), random access memory (RAM), video card, sound card, magnetic storage devices, optical storage devices, input/output (I/O) terminals, and a network interface card (NIC) (all not shown). User stations 110, 120, and 130 may optionally be connected to a printer (not shown) through the I/O terminals. Examples of the I/O terminals to which the printer may be connected are parallel, serial, universal serial bus, and IEEE 1394. Also, user stations 110, 120, and 130 may be connected to remote computing devices through a network 140. For example, network 140 may be a local area network (LAN), wide area network (WAN), such as the Internet, or wireless network. An example of a remote computing device may be server 150. User stations 110, 120, and 130 are not limited to a computer unit described above. User stations 110, 120, and 130 may be, for example, hand held computing devices, cellular telephones with computing capabilities, and other types of computing devices known in the art. In one configuration consistent with certain features of the present invention, user stations 110-130 may be operated by respective users associated with a point and/or nonpoint source.

Server 150 may be a computer system that provides data, information, applications, etc, to user stations 110, 120, and 130. Server 150 may contain standard components for inputting, outputting, manipulating, and storing data. For example, server 150 may comprise of a central processing unit (CPU), random access memory (RAM), video card, sound card, magnetic storage devices, optical storage devices, input/output (I/O) terminals, and a network interface card (NIC) (all not shown). Furthermore, server 150 may be configured to perform processes and functions consistent with certain features of the present invention. Also, server 150 may comprise of one or more storage devices that include information, such as user, watershed, trade information, and program and system data. The storage devices may also include instructions, applications, and processes that perform functions consistent with certain features related to the present invention.

One skilled in the art would realize that the configuration of nutrient trading system 100 is exemplary and is not intended to be limiting. For example, more than one server may be attached to network 140 that operates in a manner consistent with certain features related to the present invention. Furthermore, although only three user stations 110-130 are shown in FIG. 1, one skilled in the art would realize that additional (or less) user stations may be implemented without departing from the scope of the present invention.

Methods, systems, and articles of manufacture consistent with certain principles related to the present invention allow nutrient trading system 100 to facilitate nutrient trading between user stations 110-130. In accordance with one aspect of the present invention, server 150 may be configured to perform a nutrient trading process. The process may be configured in the form of a process created using various programming languages or software suites. For example, the nutrient trading process may be a program written in the Java™ programming language and hypertext markup language. In one aspect of the present invention, server 150 may include a processor (not shown) that executes the nutrient trading process located in a local or remote memory device (also not shown). One skilled in the art would realize that the configuration of the nutrient trading process is exemplary and the present invention is not limited to the examples described above.

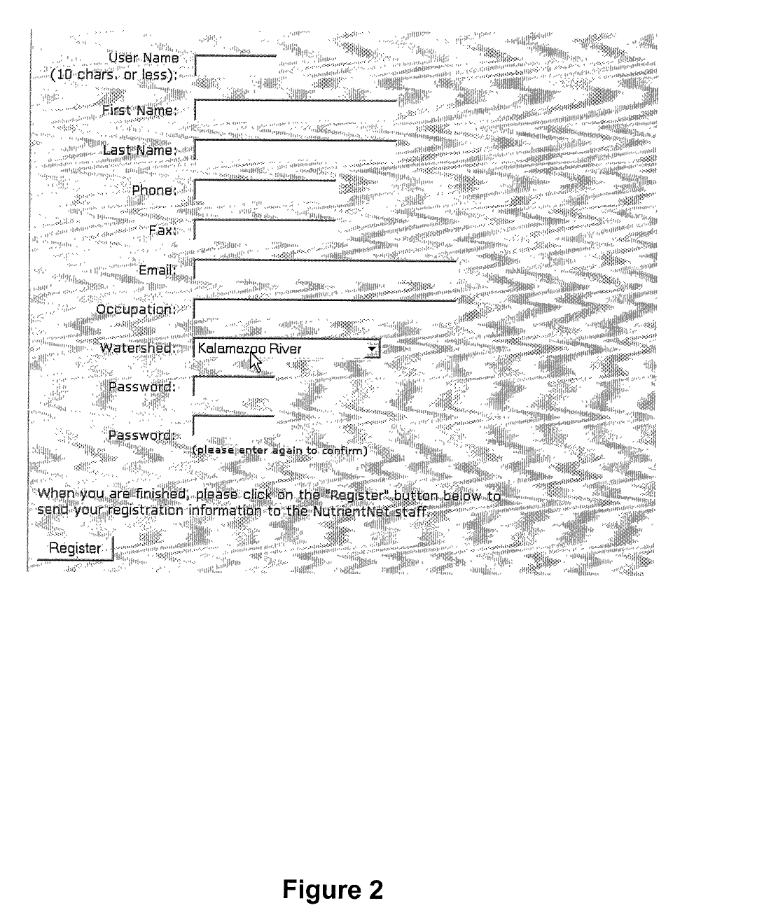

Once server 150 is accessed, it may allow the user to register. Registration may allow a user, and/or the user's associated user station (110-130) to be validated as an authorized market participant for performing nutrient trading consistent with certain features of the present invention. A registered user may be allowed to access information worksheets that provide cost management practices and amounts of available nutrient credits. A registered user may also be allowed to present offers for buying and selling credits to server 150. Therefore, server 150 ensures that posted offers have originated from only validated sources (i.e., registered users). Furthermore, registered users may be provided with information by server 150. This information may include notification associated with trading rules, watershed activities, new tools and features offered by server 150, and any other type of information that the user may find useful for performing nutrient trades in a manner consistent with certain features of the present invention. In one aspect of the present invention, server 150 may maintain a list of registered users and associated contact information. Server 150 may keep the user and contact information secure from unauthorized entities. Alternatively, server 150 may allow this information to be shared by other users, with prior approval from the registered user. FIG. 2 shows an exemplary registration form that may be provided by server 150. The registration form may include, for example, fields for a user to provide identification information, such as a name, contact information occupation information, and password data.

The nonpoint worksheet process may be initiated when a user operating auser station (110-130) accesses server 150 through network 140. Once accessed, server 150 may provide the user with various nutrient trading options. One of these options may be the worksheet process for a nonpoint source. This process may begin by server 150 prompting the user to provide an identifier, such as a user name. The user may provide this identifier (Step 310). Server 150 may then present a query for the user to provide a location of a nonpoint source. Server 150 may provide a map that the user may manipulate to identify a location of the nonpoint source on the map.

Once the user has selected the location of the nonpoint source (Step 320), the user may be prompted by server 150 to provide information associated with the nonpoint source. This information may include details describing the nonpoint source, such as, the type and dimensions of the nonpoint source and current management practices. The information may be used by server 150 to determine nutrient load associated with the nonpoint source.

After receiving the information describing the nonpoint source, server 150 may determine a nutrient load for the nonpoint source. The nutrient load, which may be a phosphorus or nitrogen load, may be determined based on the location of the nonpoint source specified by the user in step 320, the description of the nonpoint source, and the current management practices specified by the user in step 330. The nutrient load may be determined by server 150 using various environmental software models for determining the nutrient load, such as, but not limited to, a SEDMOD and RUSLE model.

Once the nutrient loads are determined by server 150, the user may be presented with a summary of the determined nutrient load information and various management practices that may be implemented at the nonpoint source. The user may be prompted to select one or more of the management practices to view (Step 340). Once the user has selected the new management practices, server 150 may prompt the user to provide information describing the new management practices selected in step 340. This information may include, for example, the economic factors, dimensions of the new management practice, construction costs, and duration of the management practice.

Once the user provides the parameter information (Step 350), server 150 may determine the cost of the selected new management practice and a number of nutrient credits based on the selected new management practice. Server 150 may provide a summary to the user of the cost efficiency for the new management practices selected in step 340 (Step 360). The summary may include a cost of implementing the management practice and an amount of nutrient credits generated by the new management practices selected in step 340 and described in step 350. The cost may be determined based on the economic information and construction costs specified by the user. The summary of best management practices may also display a cost of the new management practices based on public cost sharing and without public cost sharing. For example, in a cost sharing summary, the cost of the new management practice is determined based on a portion of the cost being subsidized by, for example, the government. The amount of subsidy may be determined from standard governmental, environmental, and agricultural subsidies and programs.

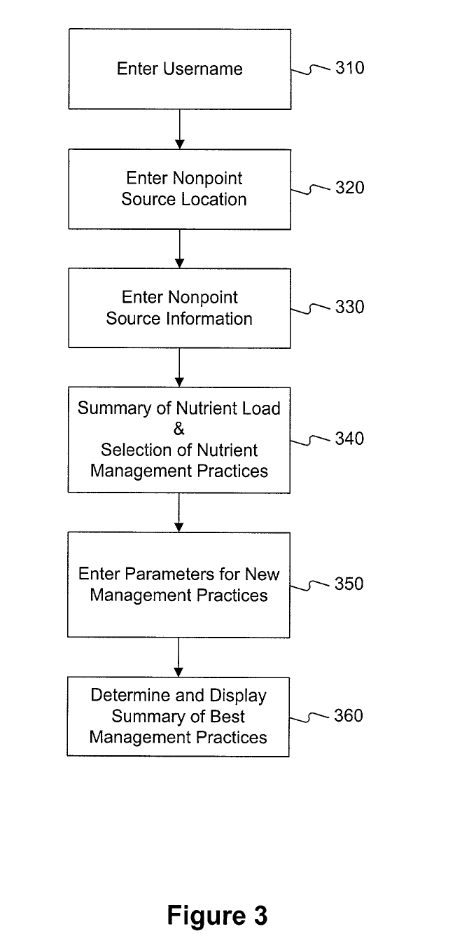

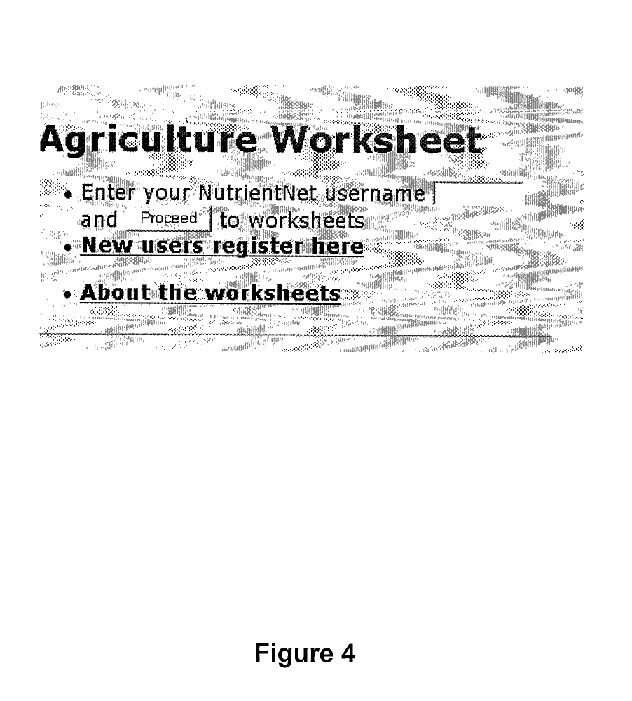

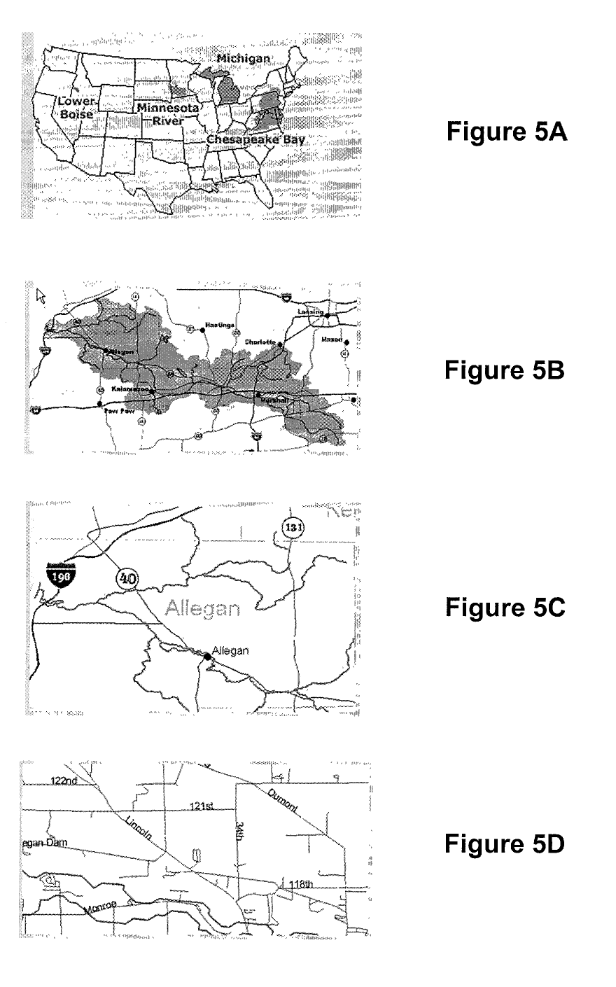

To provide a better understanding of certain aspects of the present invention, the nonpoint source worksheet process shown in FIG. 3 will now be described in relation to FIGS. 4-9. Initially, server 150 may provide a form including a field for a user to enter a user name, across network 140 to user station 110. FIG. 4 is a screen shot of an exemplary form for inputting a user name consistent with certain aspects related to the present invention. After the user enters a user name, this information is transferred to server 150 for processing. Next, server 150 may transfer a form for locating a nonpoint source as described in step 320 across network 140 to user station 110. FIGS. 5A-D are screen shots of an exemplary map form used in step 320 consistent with an aspect related to the present invention.

In one configuration consistent with certain features related to the present invention, server 150 may use a Geographical Information System (GIS) interface to manage the selection of a location on a geographical map presented to the user. The user may select a nonpoint source location by designating the location on one or more maps of varying resolutions. For example, server 150 may initially provide the map form shown in FIG. 5A to the user. The user may select a location of the nonpoint source by designating its location on the map shown in FIG. 5A. Based on the selection, server 150 may provide the map form shown in FIG. 5B across network 140 to user station 110. This map form may be a zoom view centered on the location selected by the user on the map form shown in FIG. 5A. The user may select another location of the nonpoint source by designating its location on the map shown in FIG. 5B and the selection may be transmitted across network 140 to server 150. Server 150 may continuously provide zoomed maps to the user based on previous selections until a desired location of the nonpoint source in a certain resolution is selected (See FIGS. 5C and 5D).

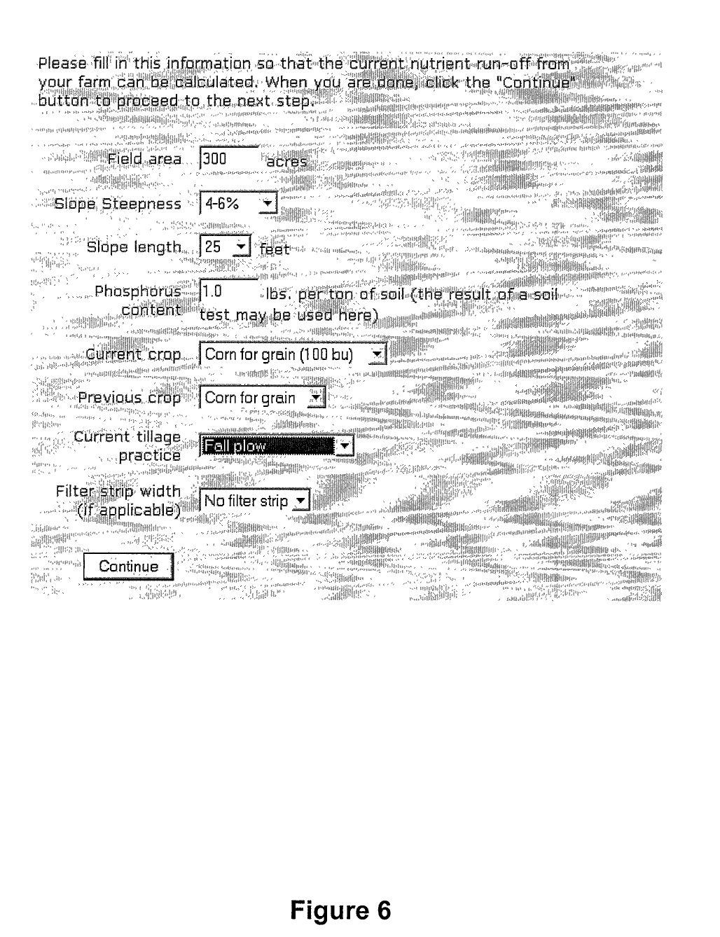

After the selection of the nonpoint source location, server 150 transfers a nonpoint information form across network 140 to user station 110. FIG. 6 is a screen shot of an exemplary form including fields for entering the nonpoint source information used in step 330 consistent with certain aspects related to the present invention. As shown in FIG. 6, the form may include fields for the user to enter different information describing the nonpoint source. The information fields may comprise, for example, field area, slope steepness, slope length, phosphorus content, current crop, previous crop, current tillage practice, and filter strip. After the user enters the information, the form may be transferred across network 140 to server 150.

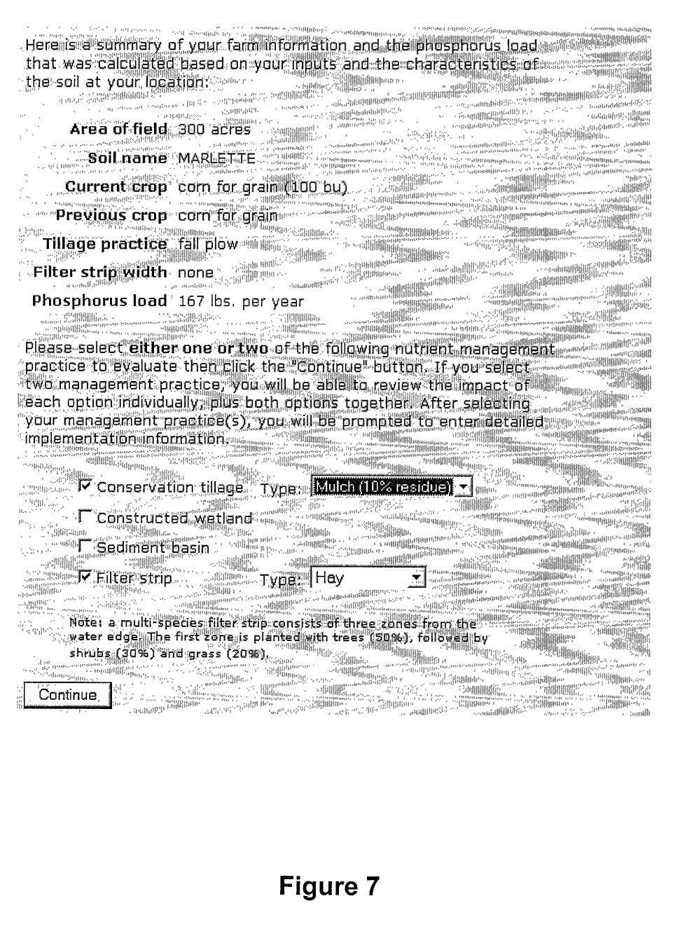

Upon receiving the nonpoint source information from the user, server 150 may determine a nutrient load, such as a phosphorus and nitrogen load, and nutrient source information associated with the nonpoint source. FIG. 7 is a screen shot of an exemplary form displaying the phosphorus and nitrogen load and nonpoint source information determined by server 150 consistent with certain aspects related to the present invention. The nonpoint source information may comprise, for example, field area, soil type, current crop, previous crop, tillage practice, and filter strip type. Also as shown in FIG. 7, the form includes fields for the user to enter new management practices to survey. The new management practices may comprise but are not limited to, for example, conservation tillage, conservation wetland, sediment basin, and filter strip. After the user selects the new management practices to survey, the selections may be provided to server 150 trough network 140. As shown in FIG. 7, a user may select new management practices, such as Conversation tillage and Filter Strip, both including a “check mark” next to a selection box.

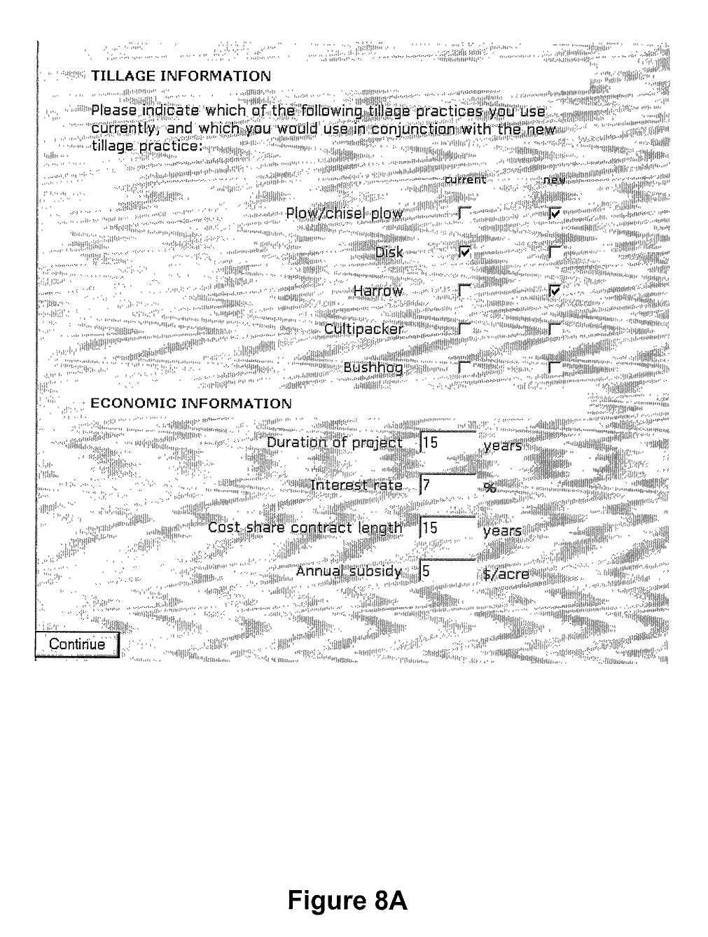

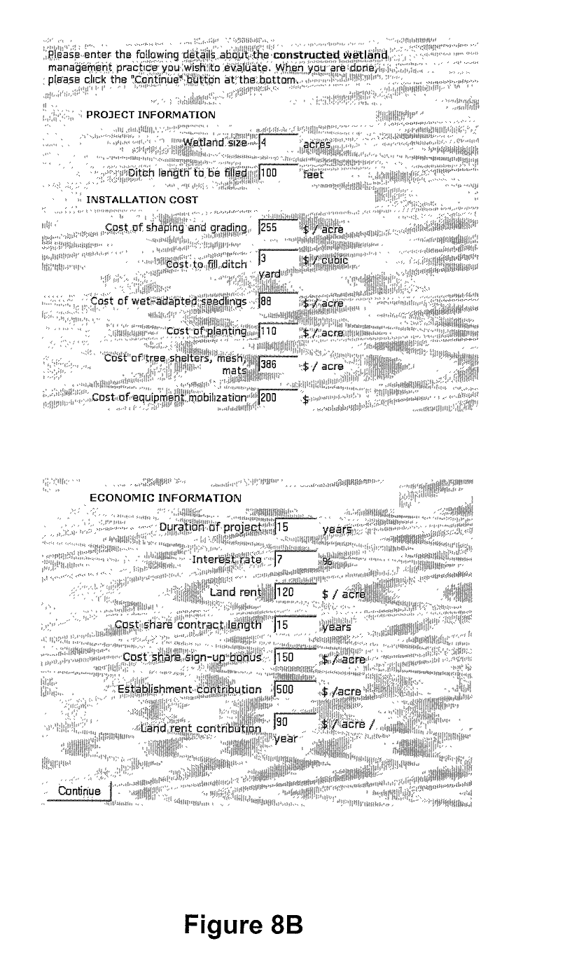

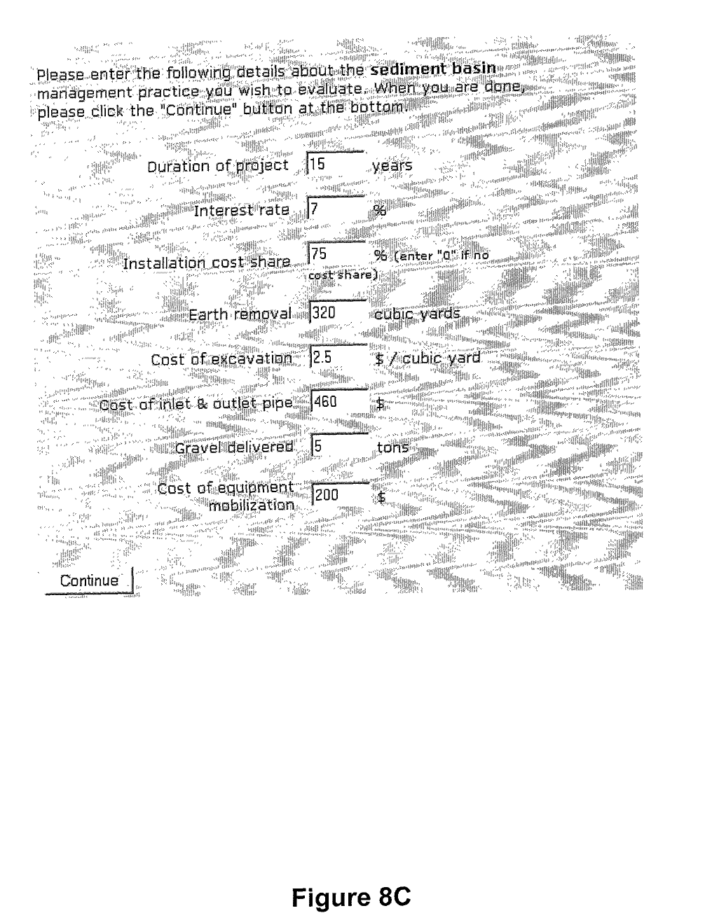

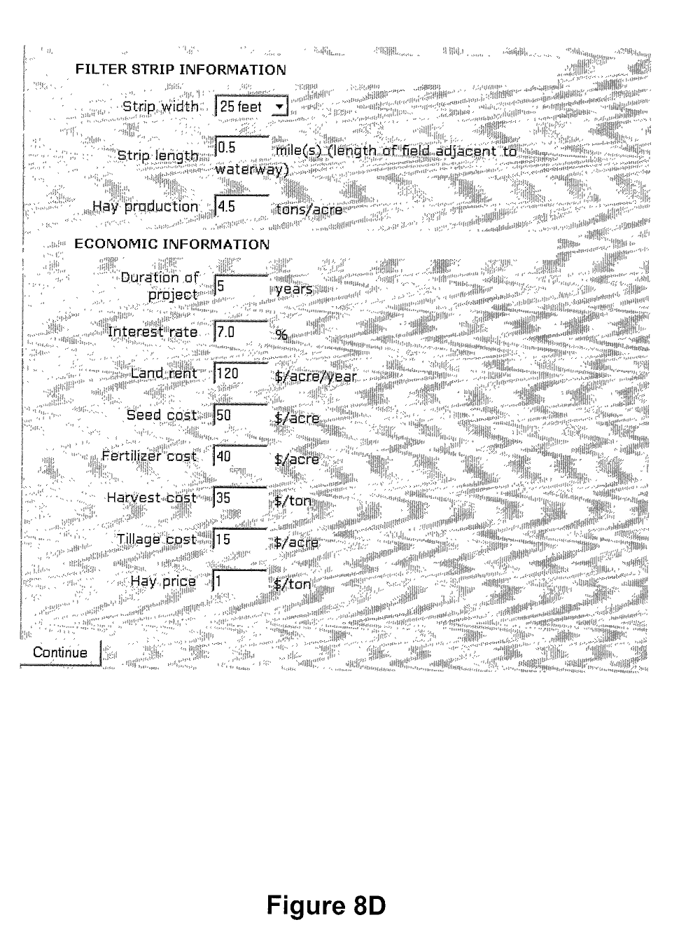

Once the user has selected the new management practices to survey, server 150 may transfer a form to user station 110 that includes fields for the user to provide information describing the selected new management practices. FIGS. 8A-D are screens shots of exemplary forms including fields for entering management practice information consistent with certain aspects related to the present invention. FIG. 8A is a screen shot of an exemplary form including fields for entering information describing a tillage management practice consistent with certain aspects related to the present invention. As shown in FIG. 8A, the form includes fields for entering different types of tillage practices to survey. Examples of the tillage practices are plow/chisel plow, disk, harrow, cultpacker, and bushhog. The form may also include fields for entering economic parameters involved with the tillage practice. Examples of the economic practices are duration of project, interest rate, cost share contract length, and annual subsidy. The user determines the values of these parameters based on the standard cost of the tillage practice.

FIG. 8B is a screenshot of an exemplary form including fields for entering information describing the construction of a wetland management practice consistent with certain aspects related to the present invention. The form may include fields associated with project information, installation cost, and economic information. The information entered for the project information may be, for example, wetland size and ditch length to be filled. The user may select these values based on the type of desired wetland. The information entered for installation cost describes the cost of constructing the wetland, which may be determined based on standard construction costs for a wetland. Examples of installation cost information may include cost of shaping and grading, cost to fill ditch, cost of wet-adapted seedlings, cost of planting, cost of tree shelters, cost of mesh mats, and cost of equipment mobilization. Furthermore, economic information may be provided by the user using the constructed wetland form described in FIG. 8B. This information may comprise, for example, project duration, interest rate, land rent, cost share contract length, cost share sign-up bonus, establishment contribution, and land rent contribution. This information is determined by economic factors based on the time period and location of the nonpoint source.

FIG. 8C is a screen shot of an exemplary form including fields for entering information describing a sediment basin management practice consistent with certain aspects related to the present invention. The form may include fields for providing information associated with, for example, economic and cost information. The economic and cost information may include information associated with a duration of a project, interest rates, installation cost shares, earth removal, cost of excavation, cost of inlet and outlet pipe, gravel delivered, and cost of equipment mobilization. This information may be determined by a user based on estimates for standard installation cost of a sediment basin and economic factors of the time period.

FIG. 8D is a screen shot of an exemplary form including fields for entering information describing a filter strip management practice consistent with certain aspects related to the present invention. This form may include fields for entering information comprising, for example, construction and economic information. Construction information may include information associated with strip width, strip length, and hay production. Economic information may include parameter information associated with a duration of a project, interest rate, land rent, seed cost, fertilizer cost, harvest cost, tillage cost, and hay price. This information may be determined by a user from estimates of standard installation cost and economic factors of the time period.

Based on the selection of a management practice, and the information provided by the user associated with the selected practice, server 150 may provide a summary of the best management practices and determine an associated amount available nutrient credits based on determined nutrient loads and the information provided by the user. For example, if a filter strip management practice was selected by the user, server 150 may determine a cost for implementing the management practice from economic and construction information entered in the form shown in FIG. 8D. This information may be, for example, seed cost, fertilizer cost, harvest, land rent, and hay price. Server 150 may determine the nutrient load for the nonpoint source taking into consideration the new management practices. Server 150 may also determine an amount of nutrient credits available for trade. The amount of nutrient credits may be determined by server 150 based on a difference between the nutrient load determined in step 340 and a determined nutrient load associated with the new management practices.

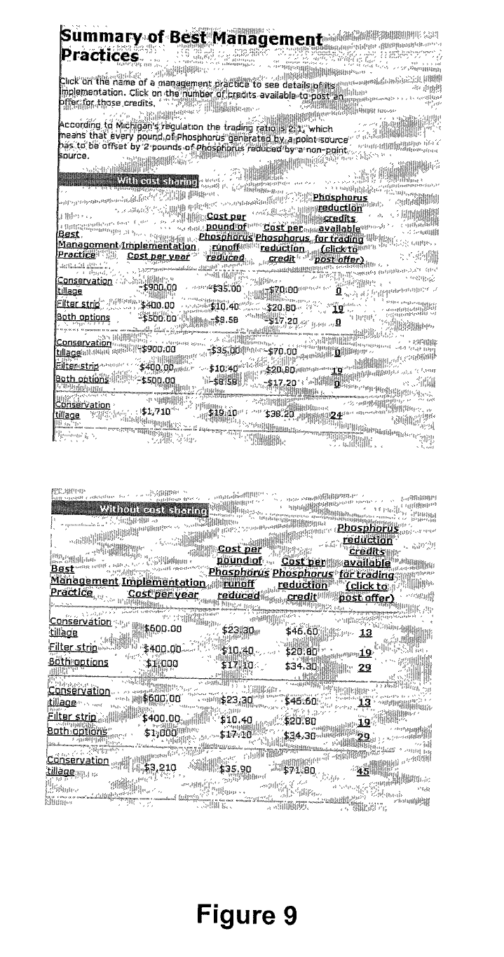

Once server 150 has determined a summary of best management practices, server 150 transfers a form displaying the summary across network 140 to user station 110. The form may include a summary of the selected new management practice. FIG. 9 is an exemplary screen shot of a form displaying the summary of best management practices consistent with certain aspects related to the present invention. As shown in FIG. 9, the form may include, for example, a summary for conservation tillage and filter strip management practice. Examples of information included are the implementation cost per year, cost per pound of nutrient runoff reduced, cost per nutrient reduction credit, and nutrient credits available for trading. The information is displayed with cost sharing and without cost sharing.

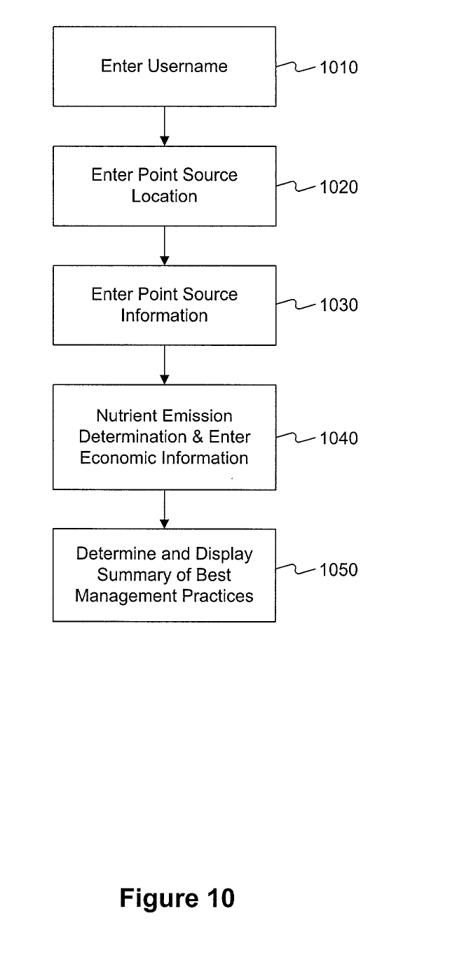

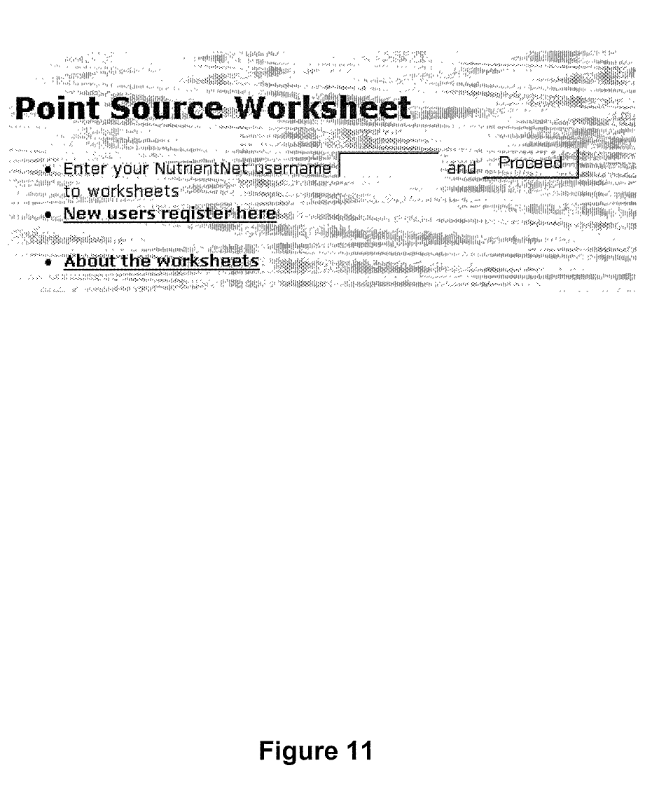

FIG. 10 is a flow chart of an exemplary point source worksheet process consistent with certain principles related to the present invention. As with the nonpoint worksheet process, the point source worksheet process may be initiated by server 150 when a user accesses server 150. The process begins with the user providing an identifier, such as a user name, in a form provided by server 150 (Step 1010). FIG. 11 shows an exemplary form that server 150 may provide to the user for providing the user name information.

Next, server 150 may provide a geographical form that allows the user to select a point source location (Step 1020). The form may be similar to those forms shown in FIGS. 5A-5D. Furthermore, server 150 may process user selections of point source locations in a manner similar to the processes described above with respect to the nonpoint source location selections. Once the user has selected the point source location, server 150 may provide the user with a form that includes fields that allows the user to enter information describing the point source.

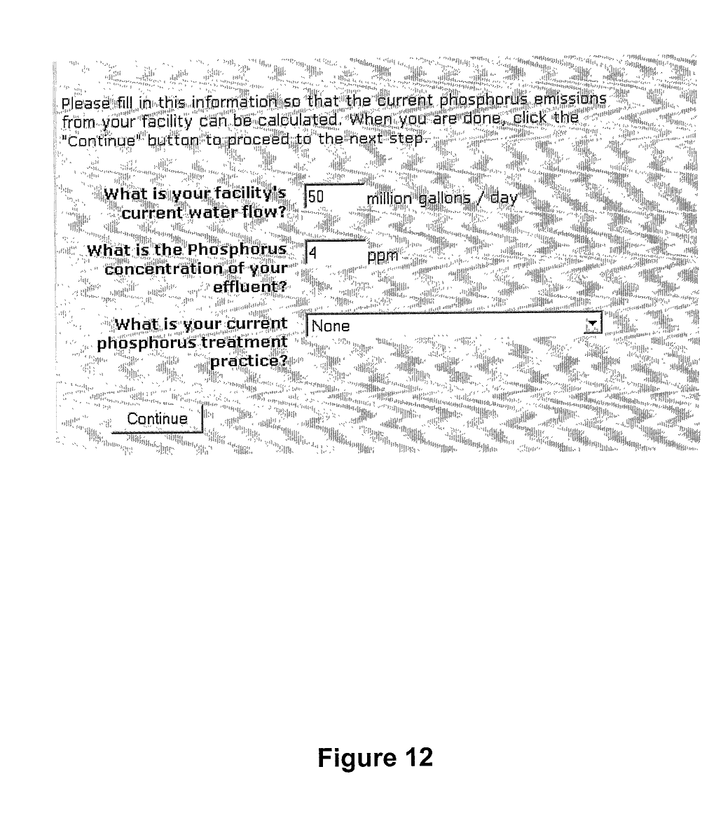

This information may include, for example, water flow from the point source, nutrient concentration of the water, and current nutrient treatment practices. FIG. 12 is a sample screen shot of an exemplary form including fields for entering the point source information consistent with certain aspects related to the present invention. As shown in FIG. 12, the form may include fields for entering information comprising, for example, the facility's water flow, phosphorus concentration of the water, and current water treatment practices. Examples of current water treatment practices are standard chemical removal, maximum chemical removal without filtration, and biological removal. The point source information may be provided to server 150 when the user completes the form shown in FIG. 12.

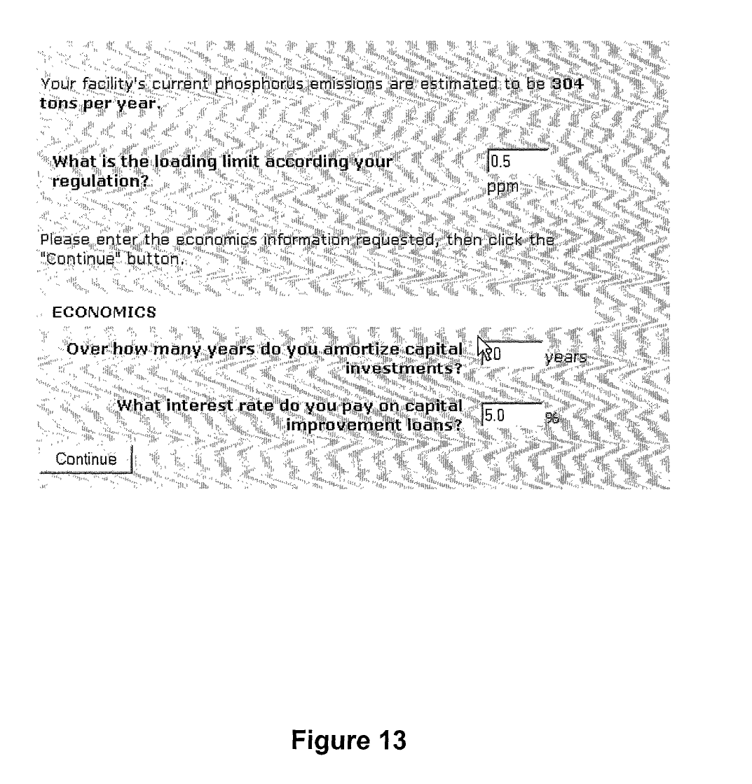

Server 150 may use the point source information provided by the user to determine nutrient emissions, such as phosphorus and nitrogen emissions, of the point source (Step 1040). Server 150 may determine the nutrient emissions based on the information provided by the user and described with respect to step 1030. For example, server 150 may determine the nutrient emissions based on the amount of nutrients remaining in a water flow after a current treatment practice removes a particular amount of nutrient. Server 150 may determine the amount of nutrients removed by the current treatment practice based on industry standards for the current treatment practice. In addition to determining nutrient emissions, sever 150 may also transfer an economic information form across network 140 to user station 110 (Step 1040). FIG. 13 is a screen shot of an exemplary form for displaying nutrient emissions and including a field for entering economic information consistent with certain aspects related to the present invention. As shown in FIG. 13, the form may include fields for entering information such as a loading limit, years to amortize capital investments, and interest rate for capital improvement loans. The user may determine the loading limit based on local regulations of nutrient limits. The interest rate and number of years may be determined based on current economic trends. After the information is provided by the user, it may be transferred across network 140 to server 150.

Server 150 may use the received economic information provided by the user to determine a summary of best management practices associated with different treatment practices (Step 1050). The management practices may include, for example, standard chemical phosphorus removal, maximum chemical phosphorus removal without filtration, standard chemical phosphorus removal with filtration, biological phosphorus removal, and biological phosphorus removal with filtration. For each treatment practice, server 150 may determine several factors related to cost and nutrient reduction. These factors may include phosphorus reduction, total annual cost, cost to switch treatment, cost per pound of phosphorus, credits need to comply, and credits available for trading. Server 150 may determine the costs based the economic information and regulatory information entered in the form described with respect to steps 1030 and 1040. Additionally, server 150 may determine an amount of available nutrient credits based on a difference between the phosphorus emissions of the current treatment practices determined in step 1030 with the phosphorus emissions of the new treatment practices. Server 150 may also determine a summary of management practices for other nutrient treatment practices such as nitrogen removal practices. Server 150 may determine the nutrient emission for the new treatment practice in a manner similar to those procedures described with respect to step 1040.

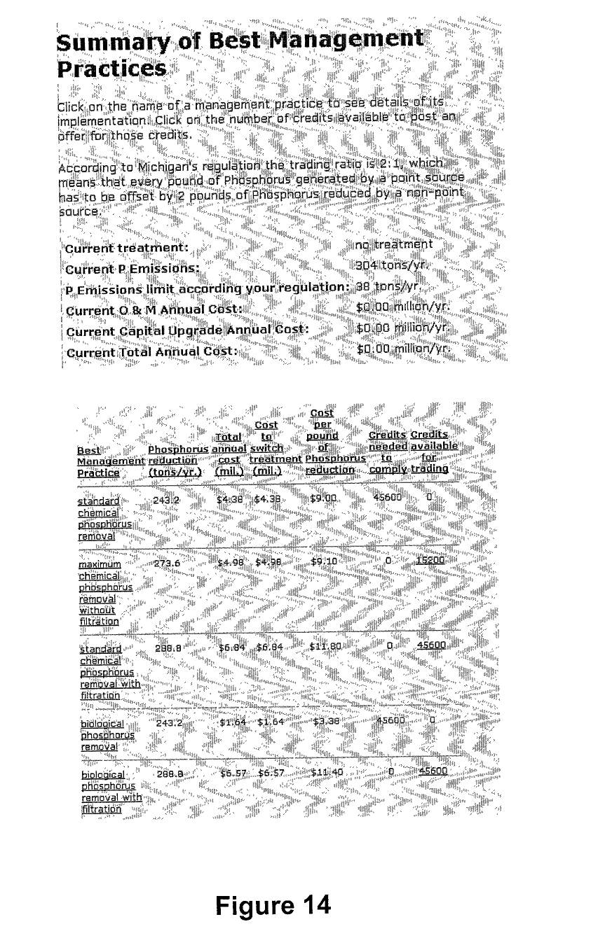

Based on the determined nutrient emissions, server 150 may determine the best management practice for the user. Server 150 may provide a form including the summary of the best management practice across network 140 to user station 110 (Step 1050). FIG. 14 is a screen shot of an exemplary form including the summary of the determined best management practices consistent with certain aspects of the present invention. As shown in FIG. 14, the form may include information comprising current treatment practices. This information may include current treatment, current phosphorus emissions, phosphorus limit, current operation and maintenance costs, current upgrade annual cost, and current total annual cost. The from also may include a summary of new management practices determined by server. For each treatment practice, several factors related to cost and nutrient reduction may be included in the form. These factors may include, phosphorus reduction, total annual cost, cost to switch treatment, cost per pound of phosphorus, credits need to comply, and nutrient credits available for trading. The form may also include a summary of best management practices for other treatment practices, such as nitrogen removal.

In addition to providing nutrient information associated with point and nonpoint sources, server 150 may also manage nutrient trading between users associated with these point and nonpoint sources. To manage nutrient trading, server 150 may provide a trading market that allows users to offer nutrient credits for sale and purchase nutrient credits from other users.

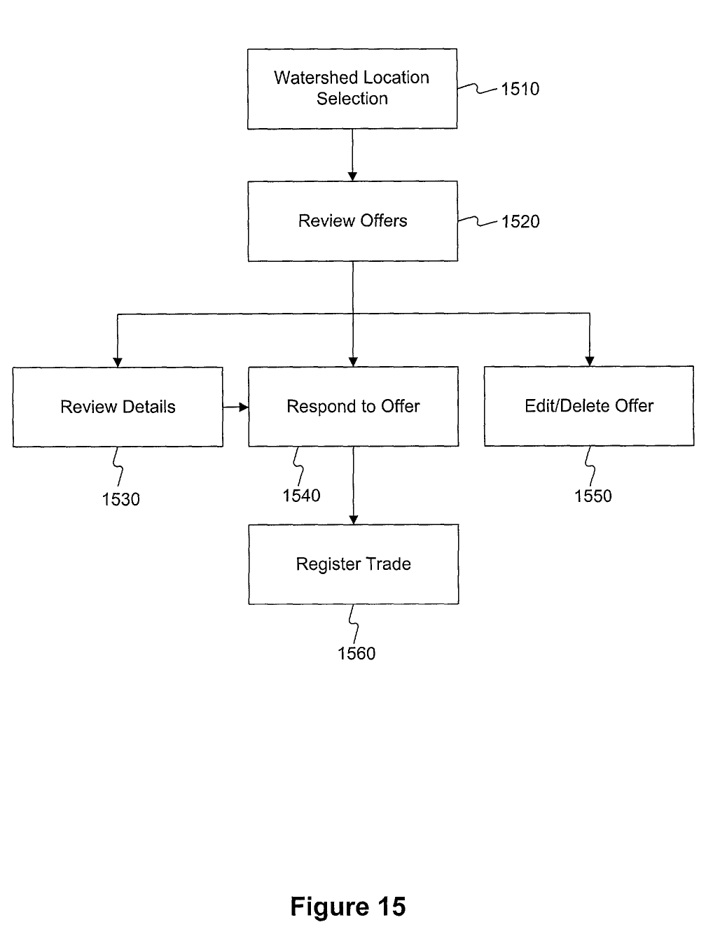

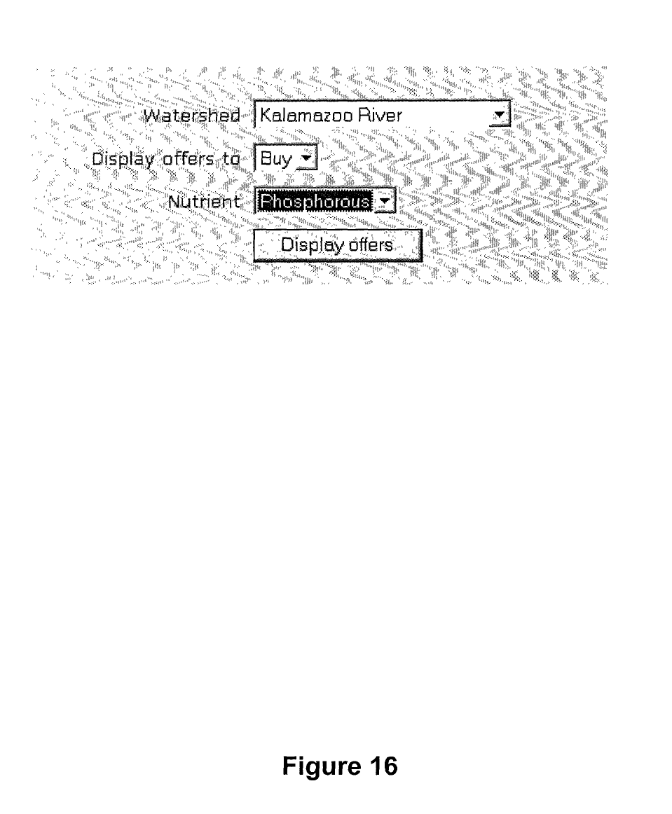

FIG. 15 shows a flow chart of an exemplary trading market process for nutrient trading consistent with certain principles related to the present invention. The process may begin when a user accesses server 150 to perform nutrient trading. The user may select a geographical area associated with a watershed in which trade offers may be analyzed (Step 1510). FIG. 16 is a screen shot of an exemplary form provided by server 150 that includes fields for entering the watershed location consistent with certain aspects of the present invention. The form may include fields for entering information such as, geographical area, type of offer (buy or sell), and type of nutrients being traded, such as phosphorous and nitrogen. Once the user has entered the appropriate information, the form is transferred across network 140 to server 150.

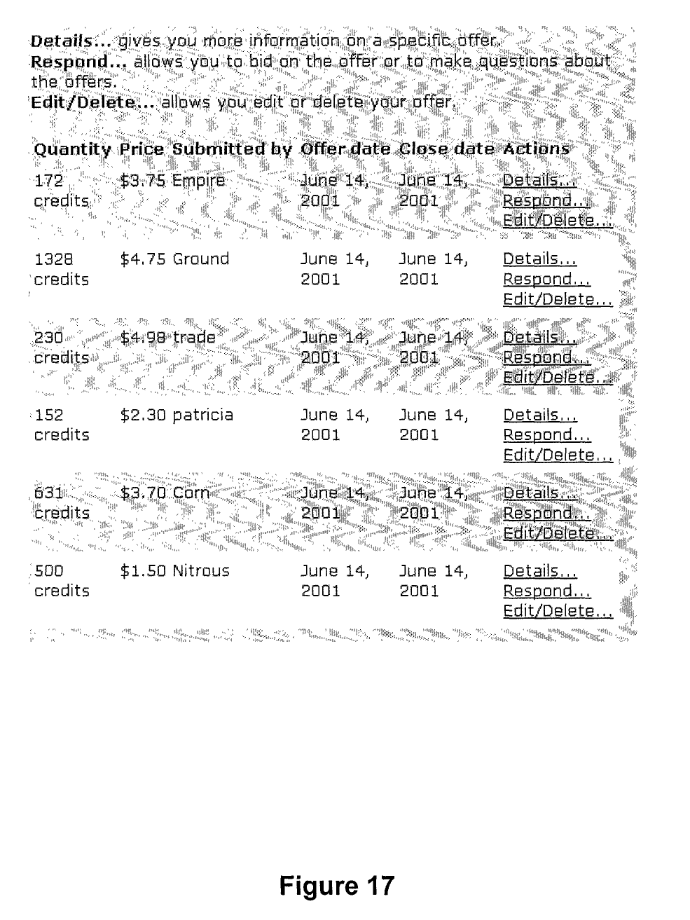

Once server 150 receives the watershed location information from the user, it may provide current nutrient trade offers to the user. FIG. 17 is a screen shot of an exemplary form including matching nutrient credit offers consistent with certain aspects of the present invention. Information included in this form may be for example amount of credits, price per credit, offer date, and close date. The form may also include fields that may enable a user to review details, respond to a trading offer, and edit/delete a trading offer. Once the user has found a nutrient credit offer of interest, the user has several options. The user may proceed to review details of an offer (Step 1530), respond to an offer (Step 1540), or edit/delete an offer (Step 1550).

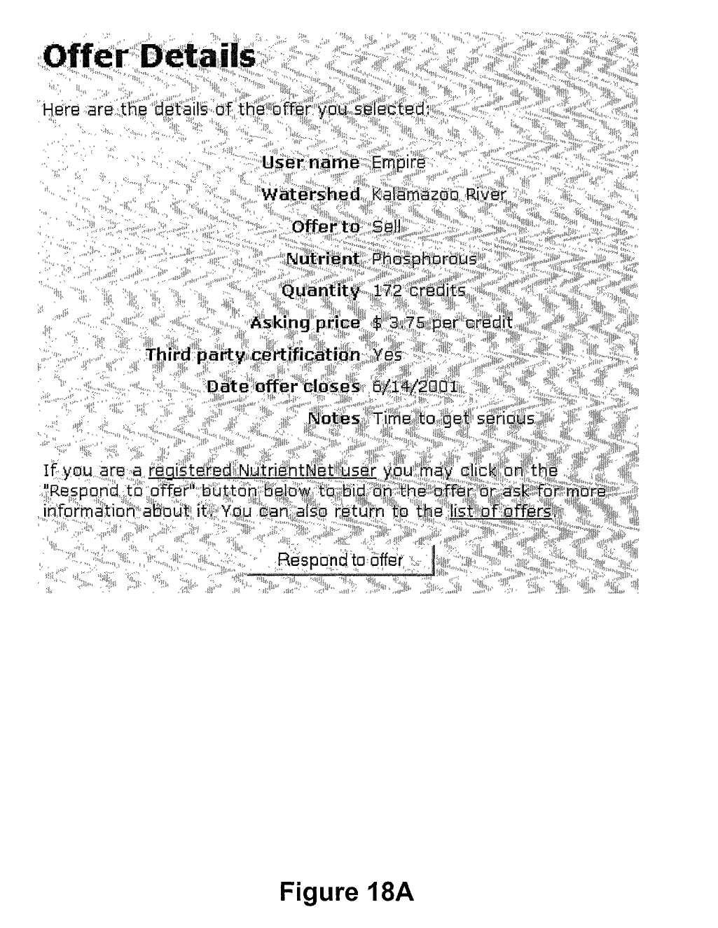

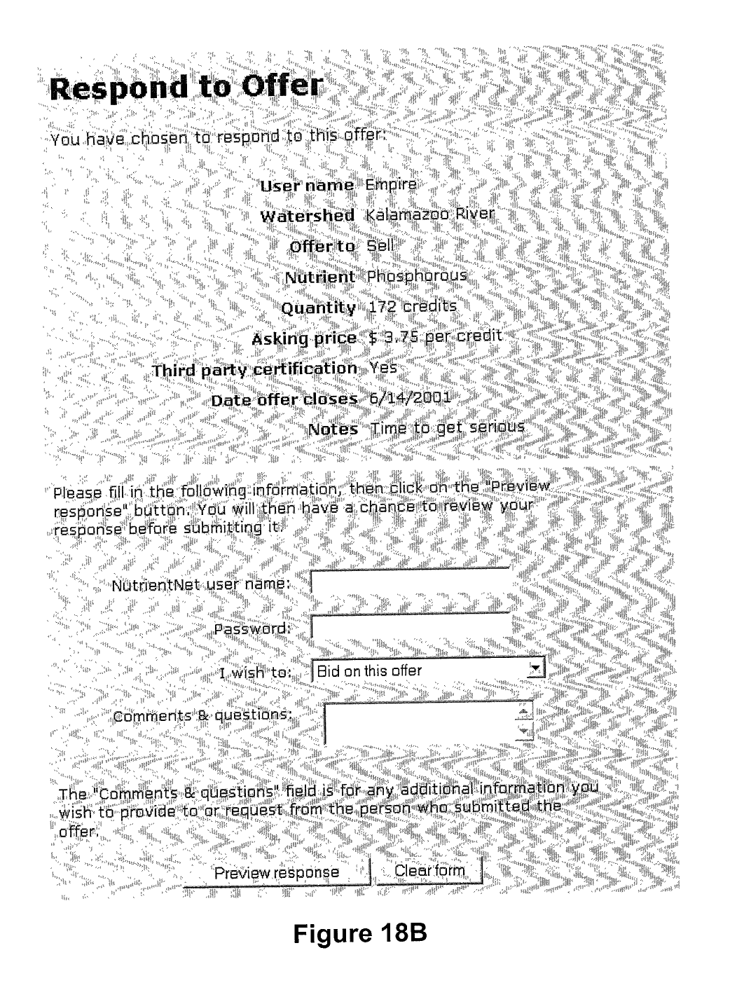

If the user selects to review details of an offer (Step 1530), the details of the offer selected by the user may be provided by server 150. The offer details displayed describe the trading offer that the user selected. FIG. 18A is a screen shot of an exemplary form for displaying offers consistent with certain aspects of the present invention. As shown in FIG. 18A, the details included in the form may include, for example, user name, watershed, type of offer, type of nutrient, quantity, asking price, certification, expiration date and comments. The form also includes a field which allows the user to respond to the offer.

After reviewing the offer, the user may respond to the offer (Step 1540). Alternatively, server 150 may allow a user to bypass the review offer process and proceed directly to responding to an offer (Step 1540). For example, if the user selects the respond offer field shown in FIG. 17, server 150 may transfer a form for responding to an offer across network 140 to user station 110. FIG. 18B is a screen shot of an exemplary form including fields for responding to an offer consistent with certain aspects of the present invention. As shown in FIG. 18B, the form may include fields for entering user name and password. The form may also include a field for entering a bid for the offer or entering a question about the offer. After the user enters information into the form fields, it may be transferred across network 140 to server 150.

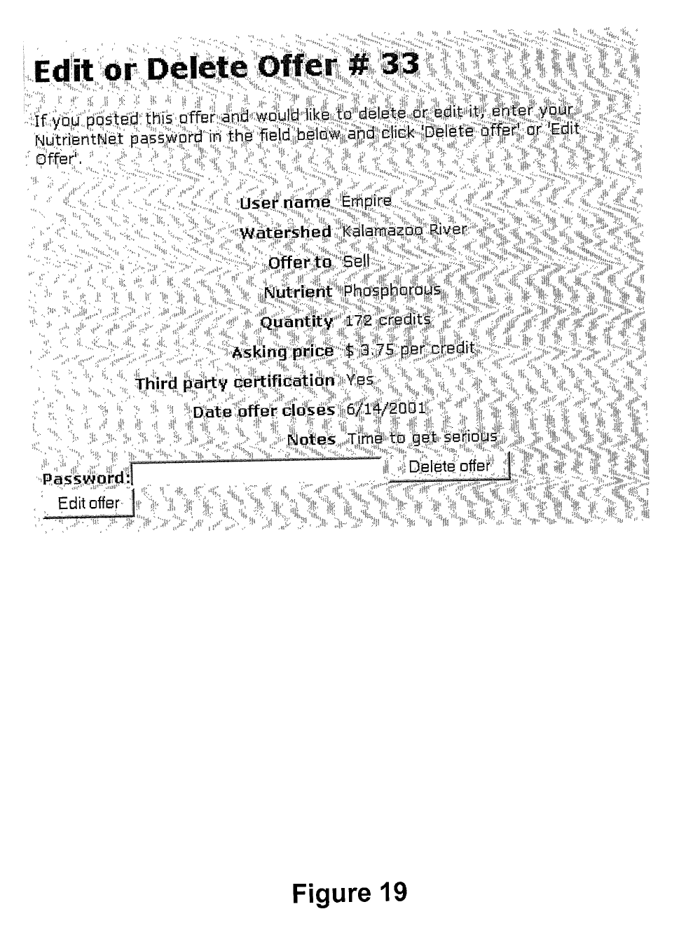

If the user selects the edit/delete offer field during step 1520, server 150 may provide an edit/delete form across network 140 to user station 110. The editing may include changing the price or amount of nutrient credit offer. The user may be prompted to supply a password before being authorized to edit or delete an offer. FIG. 19 shows a screen shot of an exemplary form including fields for entering edit/delete information consistent with certain aspects of the present invention. As shown in FIG. 19, this form may include fields for entering information such as credit price changes, nutrient credit amount changes. Also, the form may include a field that allows a user to delete an offer. This form may also include fields for entering a password and user name. Once the user has entered the appropriate information, the form may be transferred across network 140 to server 150. Server 150 may update the nutrient credit offer based on the information provided by the user during the edit/delete offer step.

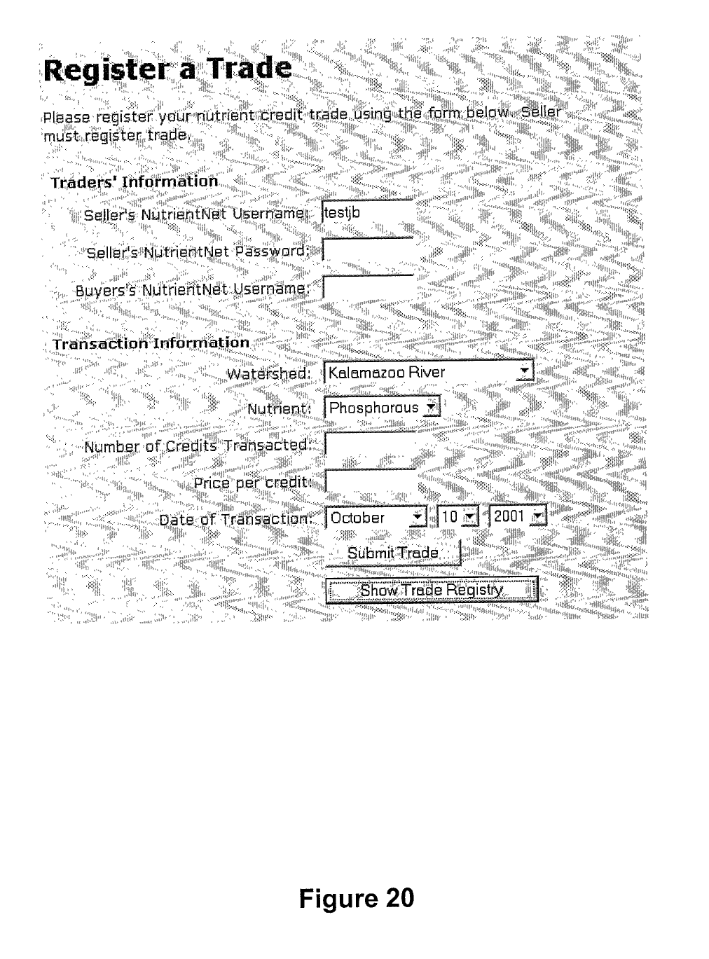

Once a bid for an offer has been forwarded to and accepted by a posting user (i.e., the user who posted a nutrient credit offer), the posting user may register the nutrient trade (Step 1560). In one configuration consistent with certain principles related to the present invention, server 150 may provide a register form to the user posting an offer to sell nutrient credits. The user may provide information associated with a completed nutrient trade with a purchasing user and submit the information to server 150. Server 150 may maintain the submitted registry information in a database. Alternatively, server 150 may also provide the registered information to a regulatory agency. Furthermore, server 150 may put the registered trade information in a trade registry, located in a database, that may be made available to users who access server 150. FIG. 20 is a screen shot of an exemplary form including fields for entering trade registration information consistent with certain aspects of the present invention. As shown in FIG. 20, the form may include fields for entering a user name, password, and a bidding user's user name. The form may also include fields such watershed location, nutrient type, number of credits traded, price per credit, and trade date. The form may also include additional fields, such as permit number, geographic location, type of implemented management practice, and verification procedure. Once the information is entered by the user, the form may be transferred across network 140 to server 150. In one configuration consistent with certain aspects related to the present invention, server 150 may provide the trade registration information in a trade registry form prior to transferring the information to a regulatory agency.

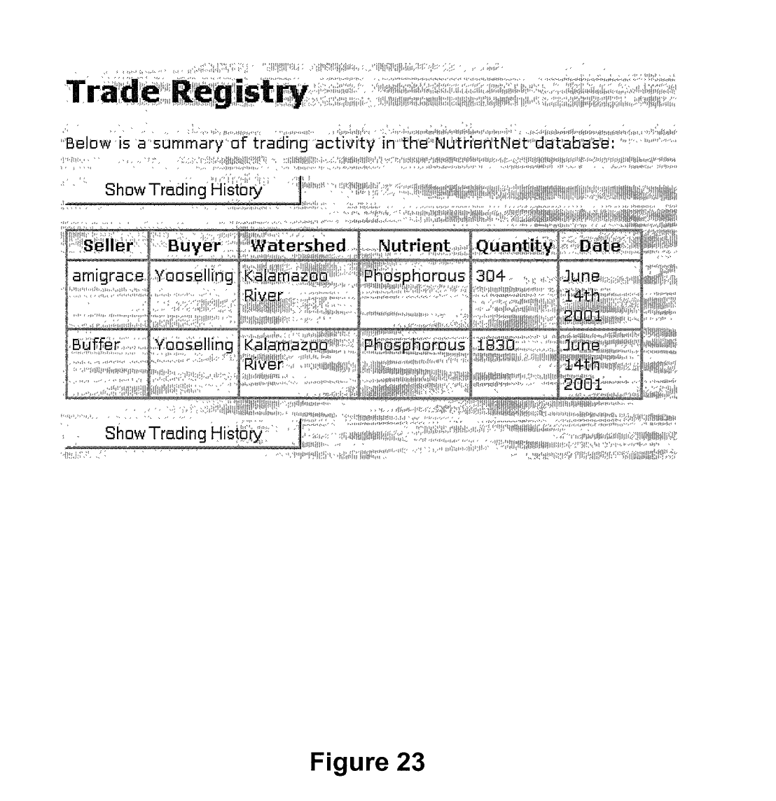

In addition to providing information associated with pending offers, server 150 may also provide the user with a summary of completed trades that have been already registered. FIG. 23 is a screen shot of an exemplary trade registry form consistent with an certain aspects of the present invention. As shown in FIG. 23, the trade registry form may include information associated with a seller, a buyer, watershed location, type of nutrient, amount of credits traded, and trade date. User located at a user stations 110, 120, and 130 may request the trade registry information from server 150.

In another aspect consistent with certain principles related to the present invention, a trade registry may be provided to a user based on a geographic location of a registered nutrient trade. For example, a user located at any one of user stations 110-130 may request a trade registry from server 150 based on a geographic location. In response, server 150 may provide a geographical form that allows the user to select a location for which to review registered trades. The form may be similar to those forms shown in FIGS. 5A-5D. Furthermore, server 150 may process user selections of point source locations in a manner similar to the processes described above with respect to the nonpoint source location selections. Once the user has selected a location, server 150 may generate a trade registry form including registered trades for the location selected by the user. The trade registry form may be, for example, similar to the form shown in FIG. 23. Server 150 may transfer the generated trade registry form across network 140 to the user.

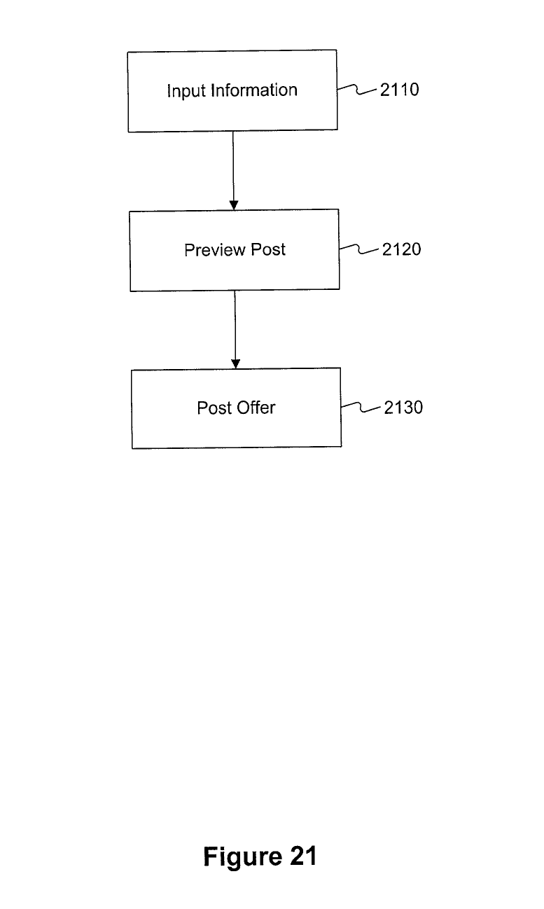

Server 150 may also allow nutrient trade offers to be posted in accordance with certain principles related to the present invention. FIG. 21 is a flow chart of an exemplary offer posting process consistent with certain aspects related to the present invention. The process may be initiated by the user providing a request to server 150 to post an offer. In response to this request, server 150 may transfer a nutrient credit offer post form across network 140 to user station 110.

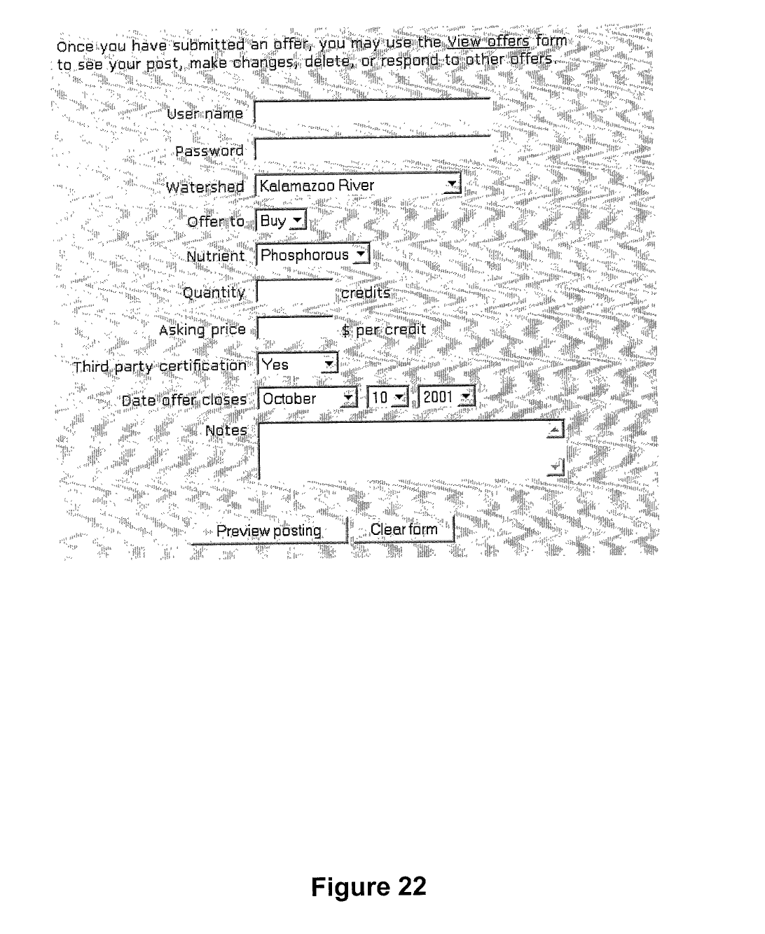

FIG. 22 is a screen shot of an exemplary form including fields for entering information detailing an offer consistent with certain aspects related to the present invention. As shown in FIG. 22, the form includes fields associated with a user name, password, watershed location, type of offer (buy or sell), type of nutrient (phosphorous or nitrogen), number of credits, price per credit, type of certification, expiration date, and comments. A user may provide the appropriate information in these fields and submit the information to server 150.

Once the offer information is received, server 150 may provide a verification form to the user. The verification form may include the information provided by the user. The user may review the information in the verification form to confirm its validity. After reviewing the offer, the posting user may post the offer to server 150 to allow other users to place bids on the offer (Step 2130). The user may provide server 150 with a request to post the offer. In response to the request, server 150 may include the posted offer with other posted offers from other users. The posted offers may be collected in a form, such as the form shown in FIG. 17. Accordingly, the user may post an offer for a nutrient trade to server 150 and the offer may be made available to other users who access server 150.

In addition to managing nutrient trades, server 150 may also manage discussion forums. Users located at a user station 110, 120, and 130 may wish to discuss nutrient trading with other users or entities. A user may discuss nutrient trading by sending messages across network 140 to other users through server 150. Also, a user may provide messages to server 150 for storage. Other users may access the stored messages by requesting server 150 to provide the stored messages. Accordingly, a user may exchange information through server 150 with other users and/or other entities, such as technical nutrient experts.

As described, methods, systems, and articles of manufacture consistent with the present invention provides nonpoint sources estimation techniques for nutrient loadings and low cost reduction practices. Furthermore, point source estimation techniques for nutrient effluents and low cost treatment practices may also be provided. It will be apparent to those skilled in the art that various modifications and variations may be made in the present invention and in construction of this nutrient trading system without departing from the scope or spirit of the invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

Additionally, although aspects of the present invention are described as being associated with data stored in memory and other storage mediums, one skilled in the art will appreciate that these aspects may also be stored on or read from other types of computer-readable media, such as secondary storage devices, like hard disks, floppy disks, or CD-ROM; a carrier wave from the Internet; or other forms of RAM or ROM. Accordingly, the invention is not limited to the above described aspects of the invention, but instead is defined by the appended claims in light of their full scope of equivalents.

What is claimed is:

1. A method for performing nutrient trading, comprising:
posting a trade offer for an amount of available nutrient credits;
receiving a bid for the trade offer;
receiving an acceptance of the bid for the trade offer to form a trade; and
registering the trade as a nutrient trade.

2. The method according to claim 1, wherein the trade offer is an offer to sell an amount of available nutrient credits.

3. The method according to claim 1, wherein the trade offer is an offer to buy an amount of available nutrient credits.

4. The method according to claim 1, wherein registering comprises:
posting the nutrient trade in a trade registry; and
transferring the nutrient trade to a regulatory agency.

5. The method according to claim 1, further comprising the steps performed before the posting step, of:
receiving a selection of a nonpoint source location;
receiving source information describing the nonpoint source; and
determining a first nutrient load based on the location and the source information.

6. The method of claim 5, further comprising:
receiving a selection of a management practice;
receiving information describing the selected management practice;
determining a cost associated with the selected management practice; and
determining an amount of available nutrient credits based on the selected management practice.

7. The method according to claim 1, further comprising the steps performed before the posting step, of:
receiving a selection of a point source location;
receiving nutrient information describing the point source; and
determining nutrient emissions of the point source based on the nutrient information.

8. The method of claim 7, further comprising:
receiving economic information for the point source;
determining an amount of available nutrient credits based on a nutrient reduction practice; and
determining a cost associated with the nutrient reduction practice.

9. A method for performing nutrient trading for a nonpoint source associated with a management practice, comprising:
selecting a nonpoint source location;
providing source information describing the nonpoint source;
selecting a new management practice associated with a first nutrient load based on the location and source information;
providing new management practice information associated with the new management practice; and
receiving nutrient information reflecting a cost of the new management practice and an amount of available nutrient credits associated with the new management practice.

10. The method according to claim 9, wherein the location is selected using a geographical information system interface.

11. The method according to claim 9, wherein the source information comprises information reflecting characteristics associated with the nonpoint source and the management practices.

12. The method according to claim 9, wherein the nutrient load is determined using an environmental model.

13. The method according to claim 12, wherein the environmental model is one of a Spatially Explicit Delivery Model and Revised Universal Soil Loss Equation Model.

14. The method according to claim 9, wherein the new management practice is one of conservation tillage, filter strip construction, wetland construction, and sediment basin construction.

15. The method according to claim 9, wherein the new management practice information comprises at least one of construction information and economic information.

16. The method according to claim 9, wherein the amount of available nutrient credits is based on a difference between a second nutrient load associated with the point source and the first nutrient load.

17. A method for determining an amount of available nutrient credits for a point source, comprising:
selecting a point source location;
providing nutrient information describing the point source;
providing economic information for the point source; and
receiving information reflecting an amount of available nutrient credits associated with a nutrient reduction practice and a cost for implementing the new management practice, wherein the nutrient reduction practice is associated with nutrient emissions based on the nutrient information and location.

18. The method according to claim 17, wherein the location is selected using a geographical information system interface.

19. The method according to claim 17, wherein the nutrient information comprises at least one of current treatment practices, current phosphorus emissions, phosphorus limit maintenance costs, regulatory information, and upgrade costs.

20. A system for performing nutrient trading, comprising:
means for posting a trade offer for an amount of available nutrient credits;
means for receiving a bid for the trade offer;
means for receiving an acceptance of the bid for the trade offer; and
means for registering the bid as a nutrient trade.

21. The system according to claim 20, wherein the trade offer is an offer to sell an amount of available nutrient credits.

22. The system according to claim 20, wherein the trade offer is an offer to buy an amount of available nutrient credits.

23. The system according to claim 20, wherein the registering means comprises:
means for posting the nutrient trade in a trade registry; and
means for transferring the nutrient trade to a regulatory agency.

24. The system according to claim 20, further comprising:
means for receiving a selection of a nonpoint source location;
means for receiving source information describing the nonpoint source; and
means for determining a first nutrient load based on the location and the source information.

25. The system of claim 24, further comprising:
means for receiving a selection of a management practice;
means for receiving information describing the selected management practice;
means for determining a cost associated with the selected management practice; and
means for determining an amount of available nutrient credits based on the selected management practice.

26. The system according to claim 20, further comprising:
means for receiving a selection of a point source location;
means for receiving nutrient information describing the point source; and
means for determining nutrient emissions of the point source based on the nutrient information.

27. The system of claim 26, further comprising:
means for receiving economic information for the point source;
means for determining an amount of available nutrient credits based on a nutrient reduction practice; and
means for determining a cost associated with the nutrient reduction practice.

28. A system for performing nutrient trading for a nonpoint source associated with a management practice, comprising:
means for selecting a nonpoint source location;
means for providing source information describing the nonpoint source;
means for selecting a new management practice associated with a first nutrient load based on the location and source information;
means for providing new management practice information associated with the new management practice; and
means for receiving nutrient information reflecting a cost of the new management practice and an amount of available nutrient credits associated with the new management practice.

29. The system according to claim 28, wherein nonpoint source location selecting means is a geographical information system interface.

30. The system according to claim 28, wherein the source information comprises information reflecting characteristics associated with the nonpoint source and current management practices.

31. The system according to claim 28, wherein the nutrient load determining means is an environmental model.

32. The system according to claim 31, wherein the environmental model is one of a Spatially Explicit Delivery Model and Revised Universal Soil Loss Equation Model.

33. The system according to claim 28, wherein the new management practice is one of conservation tillage, filter strip construction, wetland construction, and sediment basin construction.

34. The system according to claim 28, wherein the new management practice information comprises at least one of construction information and economic information.

35. The system according to claim 28, wherein the amount of available nutrient credits is based on a difference between a second nutrient load associated with the point source and the first nutrient load.

36. A system for determining an amount of available nutrient credits for a point source, comprising:
means for selecting a point source location;
means for providing nutrient information describing the point source;
means for providing economic information for the point source; and
means for receiving information reflecting an amount of available nutrient credits associated with a nutrient reduction practice and a cost for implementing the new management practice, wherein the nutrient reduction practice is associated with nutrient emissions based on the nutrient information and location.

37. The system according to claim 36, wherein the point source location selecting means is a geographical information system interface.

38. The system according to claim 36, wherein the nutrient information comprises at least one of current treatment practices, current phosphorus emissions, phosphorus limit maintenance costs, regulatory information, and upgrade costs.

39. A computer readable medium including instructions for performing a method, when executed by a processor, for performing nutrient trading, the method performed by a server comprising:
posting a trade offer for an amount of available nutrient credits;
receiving a bid for the trade offer;
receiving an acceptance of the bid for the trade offer; and
registering the bid as a nutrient trade.

40. The computer readable medium according to claim 39, wherein the trade offer is an offer to sell an amount of available nutrient credits.

41. The computer readable medium according to claim 39, wherein the trade offer is an offer to buy an amount of available nutrient credits.

42. The computer readable medium according to claim 39, wherein registering comprises:
posting the nutrient trade in a trade registry; and
transferring the nutrient trade to a regulatory agency.

43. The computer readable medium according to claim 39, further comprising the steps performed before the posting step, of:
receiving a selection of a nonpoint source location;
receiving source information describing the nonpoint source; and
determining a first nutrient load based on the location and the source information.

44. The computer readable medium of claim 43, further comprising: receiving a selection of a management practice;
receiving information describing the selected management practice;
determining a cost associated with the selected management practice; and
determining an amount of available nutrient credits based on the selected management practice.

45. The computer readable medium according to claim 39, further comprising the steps performed before the posting step, of:
receiving a selection of a point source location;
receiving nutrient information describing the point source; and
determining nutrient emissions of the point source based on the nutrient information.

46. The computer readable medium of claim 45, further comprising:
receiving economic information for the point source;
determining an amount of available nutrient credits based on a nutrient reduction practice; and
determining a cost associated with the nutrient reduction practice.

47. A computer readable medium including instructions for performing a method, when executed by a processor, for performing nutrient trading for a nonpoint source associated with a management practice, comprising:
selecting a nonpoint source location;
providing source information describing the nonpoint source;
selecting a new management practice associated with a first nutrient load based on the location and source information;
providing new management practice information associated with the new management practice; and
receiving nutrient information reflecting a cost of the new management practice and an amount of available nutrient credits associated with the new management practice.

48. The computer readable medium according to claim 47, wherein the location is selected using a geographical information system interface.

49. The computer readable medium according to claim 47, wherein the source information comprises information reflecting characteristics associated with the nonpoint source and the management practice.

50. The computer readable medium according to claim 47, wherein the nutrient load is determined using an environmental model.

51. The computer readable medium according to claim 50, wherein the environmental model is one of a Spatially Explicit Delivery Model and Revised Universal Soil Loss Equation Model.

52. The computer readable medium according to claim 47, wherein the new management practice is one of conservation tillage, filter strip construction, wetland construction, and sediment basin construction.

53. The computer readable medium according to claim 47, wherein the new management practice information comprises at least one of construction information and economic information.

54. The computer readable medium according to claim 47, wherein the amount of available nutrient credits is based on a difference between a second nutrient load associated with the point source and the first nutrient load.

55. A computer readable medium including instructions for performing a method, when executed by a processor, for determining an amount of available nutrient credits for a point source, comprising:
selecting a point source location;
providing nutrient information describing the point source;
providing economic information for the point source; and
receiving information reflecting an amount of available nutrient credits associated with a nutrient reduction practice and a cost for implementing the new management practice, wherein the nutrient reduction practice is associated with nutrient emissions based on the nutrient information and location.

56. The computer readable medium according to claim 55, wherein the location is selected using a geographical information system interface.

57. The computer readable medium according to claim 55, wherein the nutrient information comprises at least one of current treatment practices, current phosphorus emissions, phosphorus limit maintenance costs, regulatory information, and upgrade costs.

58. A method for performing nutrient trading for a nonpoint source associated with a management practice, comprising:
receiving a selection of a nonpoint source location;
receiving source information describing the nonpoint source;
determining a first nutrient load based on the location and the source information;
receiving a selection of a management practice;
receiving information describing the selected management practice;
determining a cost associated with the selected management practice; and
determining an amount of available nutrient credits based on the selected management practice.

59. The method according to claim 58, wherein the source information comprises information reflecting characteristics associated with the nonpoint source and the management practice.

60. The method according to claim 58, wherein the nutrient load is determined using an environmental model.

61. The method according to claim 60, wherein the environmental model is one of a Spatially Explicit Delivery Model and Revised Universal Soil Loss Equation Model.

62. The method according to claim 58, wherein the new management practice is one of conservation tillage, filter strip construction, wetland construction, and sediment basin construction.

63. The method according to claim 58, wherein the new management practice information comprises at least one of construction information and economic information.

64. The method according to claim 58, wherein the amount of available nutrient credits is based on a difference between a second nutrient load associated with the nonpoint source and the first nutrient load.

65. A method for determining an amount of available nutrient credits for a point source, comprising:
receiving a selection of a point source location;
receiving nutrient information describing the point source;
determining nutrient emissions of the point source based on the nutrient information;
receiving economic information associated with the point source;
determining an amount of available nutrient credits based on a nutrient reduction practice; and
determining a cost associated with the nutrient reduction practice.

66. The method according to claim 65, wherein the nutrient information comprises at least one of current treatment practices, current phosphorus emissions, phosphorus limit maintenance costs, regulatory information, and upgrade costs.

67. A system for performing nutrient trading for a nonpoint source associated with a management practice, comprising:
means for receiving a selection of a nonpoint source location;
means for receiving source information describing the nonpoint source;
means for determining a first nutrient load based on the location and the source information;
means for receiving a selection of a management practice;
means for receiving information describing the selected management practice;
means for determining a cost associated with the selected management practice; and
means for determining an amount of available nutrient credits based on the selected management practice.

68. The system according to claim 67, wherein the source information comprises information reflecting characteristics associated with the nonpoint source and the management practice.

69. The system according to claim 67, wherein the nutrient load determining means is an environmental model.

70. The system according to claim 69, wherein the environmental model is one of a Spatially Explicit Delivery Model and Revised Universal Soil Loss Equation Model.

71. The system according to claim 67, wherein the new management practice is one of conservation tillage, filter strip construction, wetland construction, and sediment basin construction.

72. The system according to claim 67, wherein the new management practice information comprises at least one of construction information and economic information.

73. The system according to claim 67, wherein the amount of available nutrient credits is based on a difference between a second nutrient load associated with the point source and the first nutrient load.

74. A system for determining an amount of available nutrient credits for a point source, comprising:
means for receiving a selection of a point source location;
means for receiving nutrient information describing the point source;
means for determining nutrient emissions of the point source based on the nutrient information;
means for receiving economic information associated with the point source;
means for determining an amount of available nutrient credits based on a nutrient reduction practice; and
means for determining a cost associated with the nutrient reduction practice.

75. The system according to claim 74, wherein the nutrient information comprises at least one of current treatment practices, current phosphorus emissions, phosphorus limit maintenance costs, regulatory information, and upgrade costs.

76. A computer readable medium including instructions for performing a method, when executed by a processor, for performing nutrient trading for a nonpoint source associated with a management practice, the method comprising:
receiving a selection of a nonpoint source location;
receiving source information describing the nonpoint source;
determining a first nutrient load based on the location and the source information;
receiving a selection of a management practice;
receiving information describing the selected management practice;
determining a cost associated with the selected management practice; and
determining an amount of available nutrient credits based on the selected management practice.

77. The computer readable medium according to claim 76, wherein the source information comprises information reflecting characteristics associated with the nonpoint source and the management practice.

78. The computer readable medium according to claim 76, wherein the nutrient load is determined using an environmental model.

79. The computer readable medium according to claim 78, wherein the environmental model is one of a Spatially Explicit Delivery Model and Revised Universal Soil Loss Equation Model.

80. The computer readable medium according to claim 76, wherein the new management practice is one of conservation tillage, filter strip construction wetland construction, and sediment basin construction.

81. The computer readable medium according to claim 76, wherein the new management practice information comprises at least one of construction information and economic information.

82. The computer readable medium according to claim 76, wherein the amount of available nutrient credits is based on a difference between a second nutrient load associated with the point source and the first nutrient load.

83. A computer readable medium including instructions for performing a method, when executed by a processor, for determining an amount of available nutrient credits for a point source, the method comprising:
receiving a selection of a point source location;
receiving nutrient information describing the point source;
determining nutrient emissions of the point source based on the nutrient information;
receiving economic information associated with the point source;
determining an amount of available nutrient credits based on a nutrient reduction practice; and
determining a cost associated with the nutrient reduction practice.

84. The computer readable medium according to claim 83, wherein the nutrient information comprises at least one of current treatment practices, current phosphorus emissions, phosphorus limit maintenance costs, regulatory information, and upgrade costs.

85. A method for providing nutrient trade information comprising:
receiving a selection of a geographic location;
determining at least one nutrient trade associated with the selected geographic location; and
providing a nutrient registry including information reflecting the at least one registered nutrient trade.

86. The method according to claim 85, wherein the trade registry includes information reflecting all registered nutrient trades associated with the selected geographic location.

87. A system for providing nutrient trade information comprising:
means for receiving a selection of a geographic location;
means for determining at least one nutrient trade associated with the selected geographic location; and
means for providing a nutrient registry including information reflecting the at least one registered nutrient trade.

88. The system according to claim 87, wherein the trade registry includes information reflecting all registered nutrient trades associated with the selected geographic location.

89. A computer readable medium including instructions for performing a method, when executed by a processor, for providing nutrient trade information comprising:
receiving a selection of a geographic location;
determining at least one nutrient trade associated with the selected geographic location; and
providing a nutrient registry including information reflecting the at least one registered nutrient trade.

90. The computer readable medium according to claim 89, wherein the trade registry includes information reflecting all registered nutrient trades associated with the selected geographic location.

91. A method for providing nutrient trade information comprising:
providing a selection of a geographic location; and
receiving a nutrient registry including information reflecting all registered nutrient trades associated with the selected geographic location.

92. A system for providing nutrient trade information comprising:
means for providing a selection of a geographic location; and
means for receiving a nutrient registry including information reflecting all registered nutrient trades associated with the selected geographic location.

93. A computer readable medium including instructions for performing a method, when executed by a processor, for providing nutrient trade information comprising:
providing a selection of a geographic location; and
receiving a nutrient registry including information reflecting all registered nutrient trades associated with the selected geographic location.
